(19) United States
(12) Patent Application Publication
(10) Pub. No.: US 2016/0203488 A1
(43) Pub. Date: Jul. 14, 2016

(54) Anti-Money Laundering Compliance Alert Life Cycle Management Process and System

(71) Applicant: Optima Compass Group, LLC, Austin, TX (US)

(72) Inventors: Jorge Guerrero, Austin, TX (US); Harrison Sanclemente, Margate, FL (US)

(73) Assignee: Optima Compass Group, LLC, Austin, TX (US)

(21) Appl. No.: 14/992,716

(22) Filed: Jan. 11, 2016

Related U.S. Application Data
(60) Provisional application No. 62/102,512, filed on Jan. 12, 2015.

(51) Int. Cl. G06Q 20/40; G06Q 50/26

(52) U.S. Cl. CPC G06Q 20/4016; G06Q 50/26

(57) ABSTRACT

A process and system for managing anti-money laundering compliance alerts using customizable sets of standards are disclosed. The Anti-Money Laundering Compliance Alert Life Cycle Management Process and System comprises a plurality of modules, including the AML Engine, the Alerts Dashboard Module, the Investigation Case Management Module, the Regulator Reports Management Module and the Risk Management Module. The Anti-Money Laundering Compliance Alert Life Cycle Management Process and System allows analysts to manage Anti-money laundering compliance exception alerts through the dynamic interaction of modules in response to financial transaction data. The Anti-Money Laundering Compliance Alert Life Cycle Management Process and System invention is a dynamically active tool for aiding analysts in reaching decisions to cancel or release financial transactions so that money laundering and fraud may be easily and efficiently prevented.

### CROSS-REFERENCE TO RELATED APPLICATIONS

This application claims benefit of U.S. Provisional Patent Application No. 62102512, which was filed on Jan. 12, 2015, and which is incorporated herein in its entirety. Additionally, this application is related to U.S. Provisional Patent Application No. 62102492 filed on Jan. 12, 2015, and to U.S. Utility patent application Ser. No. 14992639 filed on Jan. 11, 2016, which claims benefit of U.S. Provisional Patent Application No. 62102492.

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISK APPENDIX

Not Applicable

### BACKGROUND OF THE INVENTION

1. Field of the Invention

The present invention is in the technical field of financial transaction management. More particularly, the preferred embodiments of the present invention relate generally to processes, frameworks and systems for monitoring and managing financial transactions. More particularly, the preferred embodiments of the present invention relate generally to processes, frameworks and systems for monitoring and managing financial transactions to assure compliance with a set of standards. More particularly, the preferred embodiments of the present invention relate generally to processes, frameworks and systems for monitoring and managing financial transactions to assure compliance with anti-money laundering and anti-fraud standards. More particularly, the preferred embodiments of the present invention relate generally to processes, frameworks and systems for monitoring and managing financial transactions to assure compliance with a set of standards, which are customizable. More particularly, the preferred embodiments of the present invention relate generally to processes, frameworks and systems for monitoring and managing financial transactions to assure compliance with a set of standards, which are customizable in terms of type of standards and the degree to which the standards are applied. More particularly, the preferred embodiments of the present invention relate generally to processes, frameworks and systems for managing anti-money laundering compliance alerts using standards, which are customizable in both type and degree.

2. Description of the Related Art

The broad concept of systems that monitor financial transactions are known. These inventions usually involve the mere collection of financial data.

It is also known to use rules to monitor anti-money laundering compliance. However, the rules used in these inventions are immutable or provided by a government or other regulatory organization.

Dynamic anti-money laundering systems are also known. However, these existing inventions do not allow for the customization of rules by both type and degree and often attribute their dynamic nature to the dynamics of a market or the financial system.

It is also known to generate alerts for financial transactions. However, these inventions do not disclose alerts based on dynamic rules, which are customizable in both type and degree.

It is also known to use methods for detecting suspicious activity. However, these inventions usually rely on suspicious activity, which is defined by a government or other regulatory organizations and do not account for internal definitions of suspicious activity, which are customizable in both type and degree.

It is also known to use modules within systems. However, these existing inventions do not use interactive modules that subdivide the analysis of financial transactions to allow for dynamic layers of customized rules in both type and degree.

### SUMMARY OF THE INVENTION

The broad embodiments of the present invention relates to a process and system for managing anti-money laundering compliance alerts using customizable sets of standards, which comprises a plurality of interactive modules with sets of rules that are customizable by both type and degree.

In the most preferred embodiment, the Anti-Money Laundering Compliance Alert Life Cycle Management Process and System invention relates to a process and system for managing anti-money laundering compliance alerts. In the Anti-Money Laundering Compliance Alert Life Cycle Management Process and System, financial transactions may be entered through an API, by using files or by manual input. The API implements a web service, which is called by an Internet-connected device when a transaction needs to be reviewed and which gathers the appropriate transaction information for analysis. Alternatively, text files containing transaction records can be loaded into the system through a functionality that allows a user to both select the file to load and define the internal layout of the file. Manual entry of relevant transaction information into the system is also possible. Financial transaction data is first evaluated through the AML Engine, which comprises the Multivariate Dynamic Rules Engine Framework and System and a Sanctions List Engine, which are both described in U.S. Provisional Patent Application No. 62102492 and in U.S. Utility patent application Ser. No. 14992639 and which are incorporated herein in their entirety, which takes all participants in the transaction and screens their names against several sanctions lists supported by the system using an algorithm that returns approximate matches based on a relevance rating set by the user. If any of the rules for the Multivariate Dynamic Rules Engine Framework and System and/or the Sanctions List Engine is violated, then an exception alert is generated. The Anti-Money Laundering Compliance Alert Life Cycle Management Process and System comprises a plurality of modules, including the AML Engine, the Alerts Dashboard Module, the Investigation Case Management Module, the Regulator Reports Management Module and the Risk Management Module. The Alerts Dashboard Module shows compliance analysts all transactions that violated at least one rule of the Multivariate Dynamic Rules Engine or that at least one of the participants to the transaction was matched against one of the sanctions lists supported by the system. The Alerts Dashboard Module allows an analyst to decide whether a transaction should be released or canceled by using and/or reviewing one or more tools provided by the system including, but not limited to the following: Participants Profiles, which show the complete profile for all transaction participants, including basic information, addresses, phone numbers, accounts, owners, countries, products, IDs, and/or documents; Documents and Files, which show existing transaction-related documents and allows the analyst to add new ones; Document Requests, which allows the analyst to send requests for one or more documents to the FIC and which also allows the analyst to view previously sent requests and control which documents have been received; Manual/Automated Follow-Up Notes, which allow the analyst to enter and/or view notes describing the follow-up actions in response to an exception alert (some of these notes are entered automatically by the system when, for example, a document request is sent out, or a document is received and added to the transaction documents); Data Changes, which allow the analyst to change and/or enter compliance-related transaction data, such as DOBs, ID numbers and occupations; and Compliance Background, which shows the analyst relevant information for each transaction participant, such as all past transactions (with totals and averages for 15, 30, 60, 120 and 180 days), all exception alerts, investigation cases, suspicious activity reports and currency transaction reports in which the participant has been involved. Regardless of whether a transaction is canceled or released, the analyst may escalate the exception alert to an investigation case by creating a new case based on the exception alert or by adding the exception alert to an existing investigation case, which has an open status and which has suspicious matter that is related to the exception alert being reviewed by the analyst. The Investigation Case Management Module allows investigation cases to be created, viewed or modified. As stated above, cases may be created based on an exception alert (from the Alerts Dashboard) or based on an Ad hoc query (from the module). In the Investigation Case Management Module exception alerts and/or query results can be added to existing cases to support the suspicious activity being analyzed. Moreover, the Investigation Case Management Module allows other actions on cases to be entered, including the addition of supporting documents, the editing of the analysis narrative and the change of its status. The analyst may also further escalate a case by generating a suspicious activity report based on the case. Suspicious activity reports can only be created from investigation cases, which contain all the information needed on subjects, FICs and transactions to be able to file the regulator reports in different jurisdictions. The Regulator Reports Management Module allows reports to be modified to remove transactions, subjects and FICs from the final report to file as well as to change the narrative, the documents attached to it, and its status. In addition, other regulator reports, such as current transaction reports, can also be managed in this Regulator Reports Management Module. The Risk Management Module interacts with all other modules of the Anti-Money Laundering Compliance Alert Life Cycle Management Process and System. In the Risk Management Module, risk is associated to participants, FICs and Correspondents. The AML Engine retrieves information from the Risk Management Module on the risk associated with transaction participants in order to generate exception alerts when a high-risk participant is part of a transaction. The generation of an exception alert also triggers changes in the risk associated with participants, FICs and Correspondents. The Alerts Dashboard Module retrieves risk information in order to present it to analysts when they are reviewing exception alerts. Also, the escalation of an exception alert to an investigation case triggers changes in the risk associated to participants, FICs and Correspondents. The Investigation Case Management Module retrieves risk information in order to present it to analysts when they are reviewing cases. Also, the escalation of an investigation case to a suspicious activity report or regulator report triggers changes in the risk associated to participants, FICs and Correspondents. In sum, the Anti-Money Laundering Compliance Alert Life Cycle Management Process and System invention is a dynamically active tool for aiding analysts in reaching decisions to cancel or release financial transactions so that money laundering and fraud may be easily and efficiently prevented.

### BRIEF DESCRIPTION OF THE DRAWING

Illustrative and preferred embodiments of the present invention are shown in the accompanying drawings in which:

FIG. 1 is a view of a diagram of the present invention.

### DETAILED DESCRIPTION OF THE PREFERRED EMBODIMENTS

For the purpose of illustration, the present invention is shown in the most preferred embodiment of a process and system for managing anti-money laundering compliance alerts using customizable sets of standards, which comprises a plurality of interactive modules with sets of rules that are customizable by both type and degree. The most preferred embodiment is intended to run on a computer or mobile device, which accesses the system that facilitates the invention. This embodiment is not intended to limit the scope of the present invention.

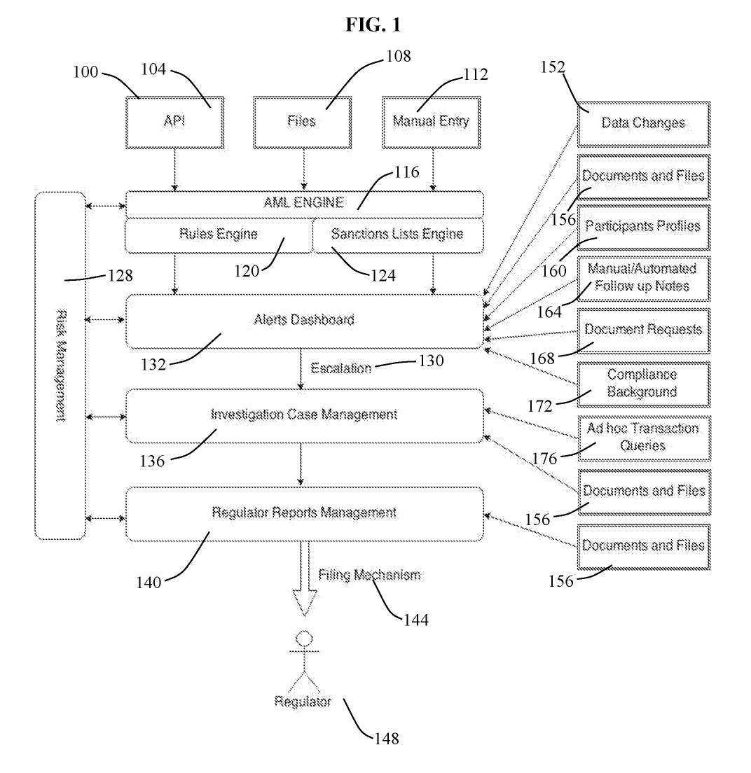

Referring now to the most preferred embodiment of the invention, FIG. 1 illustrates a diagram of the Anti-Money Laundering Compliance Alert Life Cycle Management Process and System 100, showing the interrelation between the modules 116, 128, 132, 136, 140 of the invention and describing the process flow for managing anti-money laundering compliance exception alerts.

In further detail, still referring to the invention of FIG. 1, the Anti-Money Laundering Compliance Alert Life Cycle Management Process and System 100 comprises a plurality of modules 116, 128, 132, 136, 140, including the AML Engine 116, Alerts Dashboard Module 132, the Investigation Case Management Module 136, the Regulator Reports Management Module 140 and the Risk Management Module 128. In the Anti-Money Laundering Compliance Alert Life Cycle Management Process and System 100, financial transactions may be entered through an API 104, by using files 108 or by manual entry 112. The API 104 implements a web service, which is called by an Internet-connected device when a transaction needs to be reviewed and which gathers the appropriate transaction information for analysis. Alternatively, text files 108 containing transaction records can be loaded into the system through a functionality that allows a user to both select the file 108 to load and define the internal layout of the file 108. Manual entry 112 of relevant transaction information into the system is also possible. Financial transaction data is first evaluated through the AML Engine 116, which comprises the Multivariate Dynamic Rules Engine Framework and System, or Rule Engine 120 and a Sanctions List Engine 124, which are both described in U.S. Provisional Patent Application No. 62102492 and in U.S. Utility patent application Ser. No. 14992639 and which are incorporated herein in their entirety, which takes all participants in the transaction and screens their names against several sanctions lists supported by the system using an algorithm that returns approximate matches based on a relevance rating set by the user. If any of the rules for the Rules Engine 120 and/or the Sanctions List Engine 124 is violated, then an exception alert is generated. The Alerts Dashboard Module 132 shows compliance analysts all transactions that violated at least one rule of the Rules Engine 120 or that at least one of the participants to the transaction was matched against one of the sanctions lists supported by the system in the Sanctions List Engine 124. The Alerts Dashboard Module 132 allows an analyst to decide whether a transaction should be released or canceled by using and/or reviewing one or more tools provided by the system including, but not limited to the following: Participants Profiles 160, which show the complete profile for all transaction participants, including basic information, addresses, phone numbers, accounts, owners, countries, products, IDs, and/or documents; Documents and Files 156, which show existing transaction-related documents and allows the analyst to add new ones; Document Requests 168, which allows the analyst to send requests for one or more documents to the FIC and which also allows the analyst to view previously sent requests and control which documents have been received; Manual/Automated Follow-Up Notes 164, which allow the analyst to enter and/or view notes describing the follow-up actions in response to an exception alert (some of these notes are entered automatically by the system when, for example, a document request is sent out, or a document is received and added to the transaction documents); Data Changes 152, which allow the analyst to change and/or enter compliance-related transaction data, such as DOBs, ID numbers and occupations; and Compliance Background 172, which shows the analyst relevant information for each transaction participant, such as all past transactions (with totals and averages for 15, 30, 60, 120 and 180 days), all exception alerts, investigation cases, suspicious activity reports and currency transaction reports in which the participant has been involved. Regardless of whether a transaction is canceled or released, the analyst may escalate 130 the exception alert to an investigation case by creating a new case based on the exception alert or by adding the exception alert to an existing investigation case, which has an open status and which has suspicious matter that is related to the exception alert being reviewed by the analyst. The Investigation Case Management Module 136 allows investigation cases to be created, viewed or modified. As stated above, cases may be created based on an exception alert (from the Alerts Dashboard 132) or based on an Ad hoc Transaction query 176. In the Investigation Case Management Module 136 exception alerts and/or query results can be added to existing cases to support the suspicious activity being analyzed. Moreover, the Investigation Case Management Module 136 allows other actions on cases to be entered, including the addition of supporting documents, the editing of the analysis narrative and the change of its status. The analyst may also further escalate 130 a case by generating a suspicious activity report based on the case. Suspicious activity reports can only be created from investigation cases, which contain all the information needed on subjects, FICs and transactions to be able to file the regulator reports in different jurisdictions. The Regulator Reports Management Module 140 allows reports to be modified to remove transactions, subjects and FICs from the final report to file as well as to change the narrative, the documents attached to it, and its status. In addition, other regulator reports, such as current transaction reports, can also be managed in this Regulator Reports Management Module 140 and provided to a Regulator 148. The Risk Management Module 128 interacts with all other modules 116, 128, 132, 136, 140 of the Anti-Money Laundering Compliance Alert Life Cycle Management Process and System 100. In the Risk Management Module 128, risk is associated to participants, FICs and Correspondents. The AML Engine 116 retrieves information from the Risk Management Module 128 on the risk associated with transaction participants in order to generate exception alerts when a high-risk participant is part of a transaction. The generation of an exception alert also dynamically triggers changes in the risk associated with participants, FICs and Correspondents. The Alerts Dashboard Module 132 retrieves risk information from the Risk Management Module 128 in order to present it to analysts when they are reviewing exception alerts. Also, the escalation 130 of an exception alert to an investigation case dynamically triggers changes in the risk associated to participants, FICs and Correspondents. The Investigation Case Management Module 136 retrieves risk information from the Risk Management Module 128 in order to present it to analysts when they are reviewing cases. Also, the escalation 130 of an investigation case to a suspicious activity report or regulator report dynamically triggers changes in the risk associated to participants, FICs and Correspondents.

The construction details of the invention as shown in FIG. 1 are that Anti-Money Laundering Compliance Alert Life Cycle Management Process and System 100 comprises a plurality of modules 116, 128, 132, 136, 140 for managing anti-money laundering compliance alerts, which is comprised of software, or the like, that resides on a computer, or the like, or is accessible through an Internet-connected device.

The advantages of the present invention include, without limitation, that it provides an efficient and easy-to-use means of managing anti-money laundering compliance alerts using standards, which may be customized in both type and degree.

In broad embodiment, the present invention is a process and system for managing anti-money laundering compliance alerts using customizable sets of standards, which comprises a plurality of interactive modules with sets of rules that are customizable by both type and degree. In sum, the Anti-Money Laundering Compliance Alert Life Cycle Management Process and System invention is a dynamically active tool for aiding analysts in reaching decisions to cancel or release financial transactions so that money laundering and fraud may be easily and efficiently prevented.

While the foregoing written description of the invention enables one of ordinary skill to make and use what is considered presently to be the best mode thereof, those of ordinary skill will understand and appreciate the existence of variations, combinations, and equivalents of the specific embodiment, method, and examples herein. The invention should therefore not be limited by the above described embodiments, methods, and examples, but by all embodiments and methods that are within the scope and spirit of the invention as claimed.

What is claimed is:

1. A method for managing anti-money laundering compliance alerts for financial transaction using customizable sets of standards, said method comprising:
providing a web service on one or more servers, which are configured to host said web service, said web service comprising
an AML Engine, said AML Engine comprising
a Multivariate Dynamic Rules Engine, which comprises a comprehensive set of customizable rules regarding said financial transactions that generates Exception Alerts when said set of customizable rules are violated, and
a Sanctions List Engine, which takes all participants in said financial transactions and screens said participants' names against several sanctions lists supported by the said web service using an algorithm that returns approximate matches based on a relevance rating set by a user;
an Alerts Dashboard Module;
an Investigation Case Management Module;
a Regulator Reports Management Module; and
a Risk Management Module;
providing an Application Programming Interface, which is configured to allow an Internet-connected device to remotely implement said web service;
receiving financial transaction data for said financial transactions into said web service from said user operating said Application Programming Interface on said user's said Internet-connected device;
wherein said AML Engine
analyzes said financial transactions for violations;
generates an Exception Alerts for each violation of said set of customizable rules of said Multivariate Dynamic Rules Engine or for each violation of said Sanctions List Engine; and
sends said Exception Alerts to said Alert Dashboard Module;
wherein said Alerts Dashboard Module
displays Exception Alerts to compliance analysts operating said Application Programming Interface on said compliance analysts' said Internet-connected devices along with said financial transaction data for all said financial transactions that violated at least one said customizable rule of said Multivariate Dynamic Rules Engine or for all said financial transactions in which at least one of said participants to said financial transaction was matched against at least one of said sanctions lists supported by said web service;
allows said compliance analyst to decide whether said financial transactions should be released or canceled by using
Participants Profiles Tools, which show the complete profile for all said financial transactions' said participants, including
basic information,
addresses,
phone numbers,
accounts,
owners,
countries,
products,
IDs, and/or
documents;
Documents and Files Tools, which show existing said documents and allows said compliance analysts to add new said documents;
Document Requests Tools, which allows said compliance analysts to send requests for one or more said documents to the FIC and which also allows said compliance analysts to view previously sent said requests and control which said documents have been received;
Manual/Automated Follow-Up Notes, which allow said compliance analysts to enter and/or view notes describing the follow-up actions in response to said Exception Alert and said notes, which are entered automatically by said web service when said document request is sent out or when said document is received and added to said documents;
Data Changes Tools, which allow said compliance analysts to change and/or enter compliance-related said financial transaction data, such as
DOBs,
ID numbers, and
occupations; and
Compliance Background Tools, which shows said compliance analysts relevant information for each said participant to said financial transaction, including
all past said financial transactions with totals and averages for 15, 30, 60, 120 and 180 days,
said Exception Alerts,
investigation cases,
suspicious activity reports and
currency transaction reports in which said participants of said financial transactions have been involved; and
allows said compliance analyst to escalate said Exception Alert to said investigation case by creating a new said investigation case based on said Exception Alert or by adding said Exception Alert to an existing said investigation case, which has an open status and which has suspicious matter that is related to said Exception Alert being reviewed by said compliance analysts;
wherein said Investigation Case Management Module
allows said investigation cases to be
created based on said Exception Alert from said Alerts Dashboard or based on an Ad hoc query,
viewed, or
modified;
allows said compliance analysts to add said Exception Alerts and/or query results to existing said investigation cases to support the suspicious activity being analyzed; and
allows said compliance analysts to enter other actions on said investigation cases, including
adding supporting said documents,
editing the analysis narrative, and
changing said investigation case's status; and
allows said compliance analyst to escalate said investigation case by generating said suspicious activity report based on said investigation case, said suspicious activity reports only being capable of being created from said investigation cases, which contain all the information needed on subjects, FICs and said financial transactions to be able to file appropriate regulator reports in different jurisdictions;
wherein said Regulator Reports Management Module
allows said compliance analysts to modify said regulator reports to remove said financial transactions, said subjects and said FICs from the final said regulator report to file;
allows said compliance analysts to change
said analysis narrative,
said documents attached to said regulator report, and
said regulator report's status; and
allows said compliance analysts to manage current transaction reports;
wherein said Risk Management Module
interacts with said AML Engine, said Alerts Dashboard Module, said Investigation Case Management Module, and said Regulator Reports Management Module;
associates risk information with said participants, said FICs and Correspondents;
sends said risk information to said AML Engine on the risk associated with said participants to said financial transactions in order to generate said Exception Alerts when a high-risk participant is part of said financial transaction, which also triggers changes in said risk information associated with said participants, said FICs and said Correspondents;
sends said risk information to said Alerts Dashboard Module in order to present said risk information to said compliance analysts when they are reviewing said Exception Alerts, wherein the escalation of said Exception Alerts to said investigation case triggers changes in said risk information associated to said participants, said FICs and said Correspondents; and
sends said risk information to said Investigation Case Management Module in order to present said risk information to said compliance analysts when they are reviewing said investigation cases, wherein the escalation of said investigation case to said suspicious activity report or said regulator report triggers changes in said risk information associated to said participants, said FICs and said Correspondents.

2. The method of claim 1, further comprising said user entering said financial transaction data into said Application Programming Interface manually.

3. The method of claim 1, further comprising said user entering said financial transaction data into said Application Programming Interface using text files comprising transaction records, which are loaded into said web service through a functionality that allows said user to both select said text file to load and define the internal layout of said text file.
